(19) United States
(12) Patent Application Publication
(10) Pub. No.: US 2008/0259032 A1
(43) Pub. Date: Oct. 23, 2008

(54) Wheel assembly of a computer input device

(76) Inventors: Zhen-Bang Chen, San Chong (TW); Jia-Min Huang, San Chong (TW); Xiu-Ru Zheng, San Chong (TW)

Correspondence Address: Raymond Sun, Suite 155, 20 Corporate Park, Irvine, CA, 92606, US

(21) Appl. No.: 11/804,536

(22) Filed: May 18, 2007

(30) Foreign Application Priority Data
Apr. 20, 2007 (TW) 096113876

(51) Int. Cl. G06F 3/033

(52) U.S. Cl. 345/163

(57) ABSTRACT

A computer input device has a body that includes a housing that has a top and a lateral side, with an opening provided in the lateral side. A micro switch is positioned inside the housing, with a shaft extending from the housing through the opening. A wheel assembly is located on the lateral side of the body, and extends from the opening of the body in a manner where the wheel assembly can be rotated about an axis defined by the shaft, and can be depressed against the shaft to activate the micro switch.

### BACKGROUND OF THE INVENTION

1. Field of the Invention

The present invention relates to a computer input device, and in particular, to an input device which has a lateral wheel assembly that provides different ways for controlling the operation of a computer.

2. Description of the Prior Art

The so-called “scrolling” function that is now commonly seen in computer mice and other input devices was first introduced by U.S. Pat. No. 5,530,455, where a wheel-like device was provided on the top of a computer mouse. Once the wheel is rotated, the non-displayed portion of an application can be displayed line-by-line or page-by-page. A rapid turning of the wheel generates pulses which are stored in a buffer and interpreted as energy so that scrolling continues until stopped or until the buffer is depleted. However, due to the increased number of functions introduced by the recent operating systems (O/S), an extra operating mechanism is required to deal with these additional functions, which include Flip 3D, volume control, mode shifting control, scrolling control, and resolution control, among others.

### SUMMARY OF THE DISCLOSURE

It is an object of the present invention to provide a simplified wheel assembly structure for use in an input device.

To accomplish the objects set forth above and herein, the input device according to the present invention has a body that includes a housing that has a top and a lateral side, with an opening provided in the lateral side. A micro switch is positioned inside the housing, with a shaft extending from the housing through the opening. A wheel assembly is located on the lateral side of the body, and extends from the opening of the body in a manner where the wheel assembly can be rotated about an axis defined by the shaft, and can be depressed against the shaft to activate the micro switch.

### BRIEF DESCRIPTION OF THE DRAWINGS

FIG. 1 is a perspective view of an input device according to the present invention.

FIG. 2 is an exploded perspective view of the device of FIG. 1.

FIG. 3 is a cross-sectional view of the device of FIG. 1 taken along line A-A.

FIG. 4 is a cross-sectional view of the device of FIG. 1 taken along line B-B.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. The input device according to the present invention can be a mouse, trackball, game controller or the like.

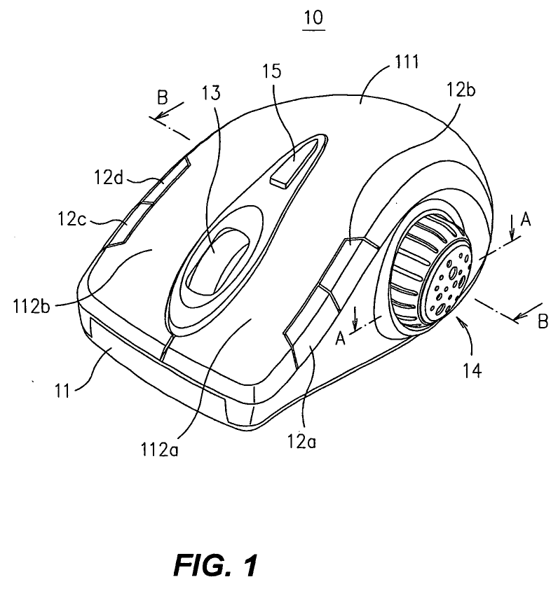

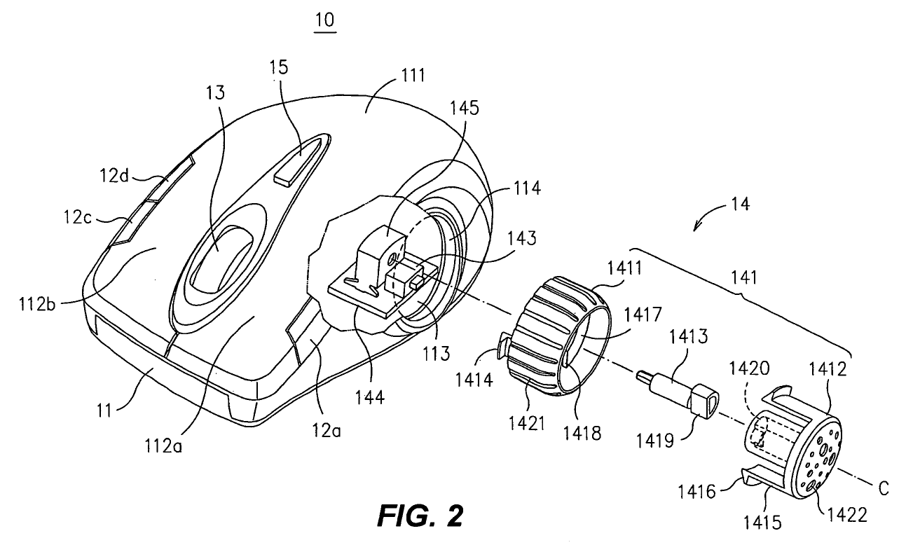

Referring to FIGS. 1 and 2, a computer input device 10 according to the present invention is illustrated as being embodied as a computer mouse, although it can be embodied in the form of any conventional input device. The input device 10 has a body 11 and an upper housing 111. The upper housing 111 has a left button 112a, and a right button 112b. Additional buttons 12a-12d can also be arranged about the upper housing 111. A wheel 13 is positioned on the top of the upper housing 111, and can be the same as any conventional wheel that is used in a conventional scrolling mouse. The input device 10 further includes a wheel assembly 14 that is positioned on a lateral side of the upper housing 111, with the wheel assembly 14 protruding from an opening 113 in lateral side of the upper housing 111. A light indicator 15 is provided on the upper housing 111 and is configured to indicate a state of the capacity of electricity within the body 11 if the input device 10 is a wireless input device.

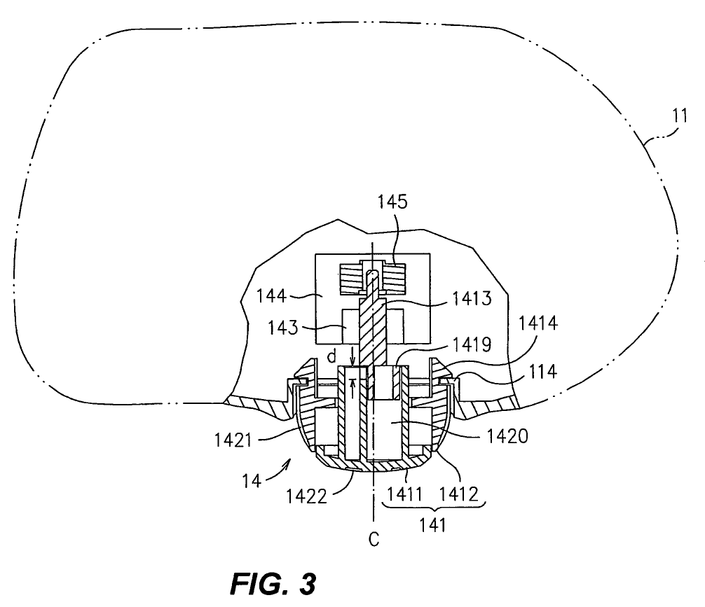

The wheel assembly 14 has an outer wheel 1411 and an inner wheel 1412. Referring also to FIG. 3, the outer wheel 1411 has at least one hook 1414 for removably engaging a flange 114 in the opening 113 of the upper housing 111. A plate 144 is positioned inside the upper housing 111, and carries thereon a micro switch 143 and an encoder 145. The micro switch 143 is positioned inside the upper housing 111 and between the encoder 145 and the inner wheel 1412.

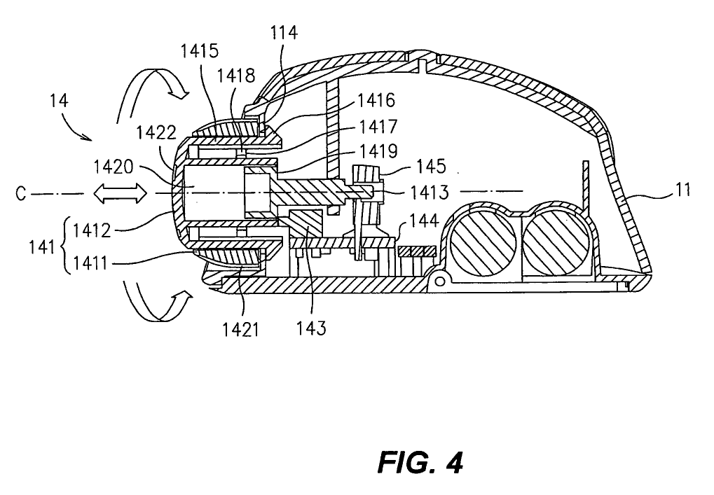

Referring also to FIG. 4, the inner wheel 1412 has at least an extension 1415 that extends towards the opening 113. The inner wheel 1412 is fixedly accommodated within the outer wheel 1411 by inserting each extension 1415 into a slit 1418 in the outer wheel 1411. Each extension 1415 has a hook 1416 that also removably engages the flange 114. The hooks 1416 and 1414 are coupled to the flange 114 at different angled positions so that the inner wheel 1412 can move independently from the outer wheel 1411. The inner wheel 1412 has a hole 1420 for tightly receiving a large end 1419 of a shaft 1413 that defines a central axis. A small end of the shaft 1413 is coupled to the encoder 145. The encoder 145 can be embodied in the form of a conventional optical encoder, such as described in U.S. Pat. No. 5,530,455, or a conventional rotary conduct encoder, such as described in U.S. Pat. No. 6,507,334. Rotation of the shaft 1413 will cause the encoder 145 to generate corresponding control signals to the computer.

When a user rotates the outer wheel 1411, the inner wheel 1412 that is carried inside the outer wheel 1411 will force the shaft 1413 to rotate together, thereby causing the encoder 145 to generate a control signal to a computer due to the rotation of the shaft 1413. In addition, to activate the microswitch 143, the user depresses the inner wheel 1412, which causes the inner wheel 1412 to move along the shaft 1413 (i.e. see direction C) and push the shaft 1413 to move a distance “d” towards the encoder 145. Inward movement of the inner wheel 1412 will be stopped by a rim 1417 carried on the inside of the outer wheel 1411.

Thus, the wheel assembly 14 provides the input device 10 with two additional ways to control the operation of a computer: (i) by rotating the outer wheel 1411, and (ii) depressing the inner wheel 1412.

In order to improve the operation of the wheel assembly 14, the periphery of the outer wheel 1411 or the outside of the inner wheel 1412 may be provided with grooves 1421 or rough surfaces 1422 as to increase the friction with the user's fingers.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer input device comprising:
a body that includes a housing that has a top and a lateral side, with an opening provided in the lateral side;
a micro switch positioned inside the housing, with a shaft extending from the housing through the opening;
a plurality of buttons located on the housing;
a wheel provided on the top of the housing; and
a wheel assembly located on the lateral side of the body, and extending from the opening of the body in a manner where the wheel assembly is rotated about an axis defined by the shaft, and is depressed against the shaft to activate the micro switch.

2. The input device as claimed in claim 1 wherein one end of the shaft is coupled to an encoder, and the micro switch is positioned adjacent the encoder.

3. The input device as claimed in claim 1 wherein the wheel assembly has an inner wheel coupled to the shaft, and an outer wheel surrounding the inner wheel.

4. The input device as claimed in claim 3 wherein each of the inner wheel and the outer wheel has a hook for removably engaging a flange that is provided at the opening of the body.

5. A computer input device, comprising:
a body that includes a housing that has a lateral side, with an opening provided in the lateral side;
a micro switch and an encoder positioned adjacent each other inside the housing, with a shaft extending from the housing through the opening and being coupled to the encoder, the shaft defining an axis; and
a wheel assembly located on the lateral side of the body, the wheel assembly having an inner wheel and an outer wheel that surrounds the inner wheel, with the shaft coupled to the inner wheel, wherein the outer wheel is rotated to cause the inner wheel and the shaft to rotate together, and wherein the inner wheel is depressed along and rotated about the axis so as to activate the micro switch.
